(19) United States
(12) Patent Application Publication
(10) Pub. No.: US 2005/0208459 A1
(43) Pub. Date: Sep. 22, 2005

(54) Computer game combined progressive language learning system and method thereof

(76) Inventors: Zechary Chang, Taipei (TW); Ken Kung, Beijing (CN)

Correspondence Address: RABIN & BERDO, P.C., Suite 500, 1101 14 Street, N.W., Washington, DC, 20005, US

(21) Appl. No.: 10/800,664

(22) Filed: Mar. 16, 2004

(51) Int. Cl. A63F 13/00; G06F 19/00

(52) U.S. Cl. 434/169; 463/1

(57) ABSTRACT

A computer game combined progressive language learning system and method is disclosed. During playing process in playing mode, the system can activate corresponding learning process in learning mode through active or passive triggered events. Accordingly, the system combines playing and learning completely by the triggered events, and can adjust playing and learning modes progressively according to learning records and evaluation results. Thus users can get fully learning during playing.

### BACKGROUND OF THE INVENTION

1. Field of Invention

The present invention relates to a language learning system and its method, especially to a language learning system and its method that is applicable to computer games and using playing process's triggered events to activate a progressive learning process.

2. Related Art

The process of learning is long and painful, so is learning a language. As computer technology develops continuously, people start to search for an easier, more enjoyable and more effective learning method, especially for kids that are learning and students, who have greater needs in this area.

In the vast number of learning theories, engaged learning is currently one of the most popular. Engaged learning allows the learners to concentrate on the learning process intensely, so the learners can achieve maximum learning results. Therefore, there are many language learning systems in the market that are labeled as language learning systems allowing engaged learning for learners. These systems also use much computer hardware and software technology to design relaxing and joyful leaning methods for learners, so they are engaged in the learning process.

For example, some language learning systems insert playing units into the learning process, to increase the engaging level of the learners. These systems can increase the learning desire and effects, and make the learning process more relaxing and joyful. However, if the overall learning process has a higher ratio of learning units, it cannot maximize the attractions to the learners, and the learners cannot increase the learning desire and achieve best learning results.

Therefore, developing an attractive and intergraded language learning system that allows learners to progressively learn in a relaxing and enjoyable learning environment to achieve best learning results is the next direction focused by the language learning system industry.

### SUMMARY OF THE INVENTION

Therefore, the invention reveals a computer game combined progressive language learning system and its method, which integrates learning into playing completely to allow complete engaged language learning for learners.

The invention's technique has characteristics of: active or passive triggered events controlled by users in the playing process generated by the playing mode. They activate the corresponding learning mode's learning process to completely integrate learning into playing. It uses the various active and passive triggered events in the playing process to achieve the main goal of complete integration of playing and learning, and also simultaneously adjust the learning and playing modes progressively, according to learning records and evaluation results, to achieve the other goal of obtaining learning effects effectively while play.

To achieve the effects of the described goals, the invention revealed computer combined progressive language learning system comprises of the following four major parts: 1. A user control interface; 2. A playing module, comprising of a playing element database and playing operating unit; 3. A learning module, comprising of a language element database, learning executing unit, and learning adjustment unit; and 4. An event triggering module.

Also, the in the invention revealed computer progressive language learning method comprises of the following steps: first, activate the game and determine the playing mode and learning mode; then, according to the game module execute the game initialization and start the playing process. As events are triggered during the game progress, activate the learning mode and execute the corresponding learning process. As the learning process is in progress, execute learning recording and evaluating, then store the results. Finally, according to the learning records and evaluations of the learning process, adjust the learning mode and playing mode simultaneously to achieve progressive learning.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and is thus not limitative of the present invention, wherein:

FIG. 1 illustrates the system structure of the invention;

FIG. 2 illustrates the flow diagram of the invention;

FIG. 3 illustrates the adjustments of the invention;

FIG. 4 illustrates the elements combining condition of the invention; and

FIGS. 5a and 5b illustrate the active and passive event triggers of the invention.

### DETAILED DESCRIPTION OF THE INVENTION

The invention reveals a computer game combined progressive language learning system and its method. The following explains the invented system and its method by using the described known technical characteristics to achieve the effects of the described goal:

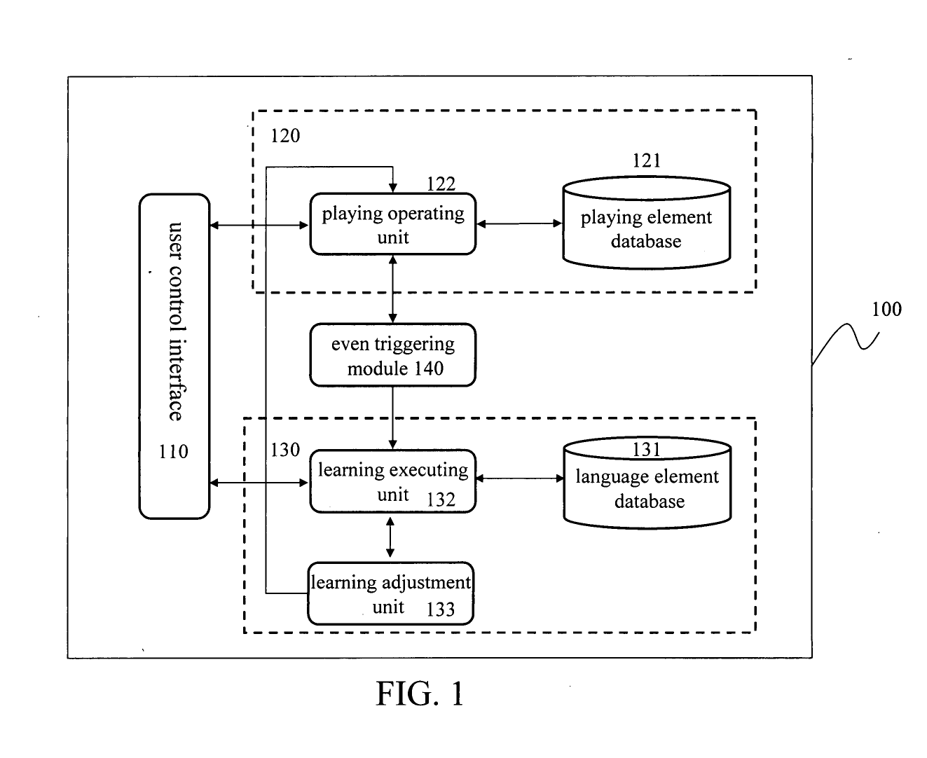

First, FIG. 1 illustrates the invention's structural diagram. The invention is structured on a playing platform 100, and comprises of the following four following parts: 1. A user control interface 110, 2. A playing module 120, 3. A learning module 130, and 4. An event trigger module 140. They are each described below:

1. User control interface 110, providing the user's (meaning the learner's) operation control of playing process and learning process. Usually by using many control keys with different functions, to allow users to choose and execute commands, such as trigger events during the playing process, and answering the learning questions during the learning process.

2. Playing module 120, providing a playing process according to the predetermined playing mode of the system, and following the user's operation control to execute the playing process, comprises of:
2a. Playing element database 121, used to store the various playing elements needed during the playing mode's playing process. Playing elements comprises of: game background, game music, game items, game rules, game engines, etc.
2b. Playing operating unit 122, first using the playing process set by the playing mode at the beginning of the game, then using the received operating control by the user to control the game progress; it retrieves more than one playing element from the playing element database 121, and is responsible for receiving operating controls from the users to the playing process.

The playing mode's settings are used to determine the type of playing process; when the game is started, predetermined playing mode is used to produce the playing process. In fact, a playing mode can also use the user control interface 110 and allow users to set the mode.

3. Learning module 130, using the predetermined learning mode by the system to provide a learning process, and using users' operating controls to execute the learning process, comprises of:

3a. Language element database 131, used to store the various language elements needed during the execution of a learning mode's learning process. According to different learning modes, language elements from a low to high level (learning difficulty from easy to difficult) can also divide into: the alphabet, words, phrases, sentences, articles. According to the combinations of the language elements, it can also be divided into different types, such as: text, sound, and image (including still pictures and animated pictures).

3b. Learning executing unit 132, used by the event triggering module 140 generated triggered events, retrieving more than one language element from a language element database 131 to produce a corresponding learning process, and accepting the operating control by users to the learning process. The language element combination condition of the event progress can use the described various forms, such as text, sound, and images, to form a multimedia format.

3c. Learning adjustment unit 133, based on the learning records and evaluation results of users during the learning process, to simultaneously adjust the playing mode of playing executing unit 122 and the learning mode of learning executing unit 132. Actually, learning adjustment unit 133 also comprises of recording and evaluating the learning process of users during the learning process execution. The goal of evaluation is to monitor the users' learning levels and conditions, and simultaneously adjust the playing and learning process accordingly. When the game is over, learning adjustment unit 133 can store the learning records and evaluation results, which can be used when the users execute the game learning process next time to determine the system predetermined playing and learning mode.

The learning mode's settings are used to determine the learning process type and content. When the game has started, the predetermined learning mode is used to produce the corresponding learning process. In fact, the learning mode can be set by the users using the user control interface 110.

4. Even triggering module 140, used to produce triggered events according to game executing unit 122 during the playing process, and demanding the learning executing unit 132 to activate the corresponding learning process. Event triggering module 140 is independent from playing module 120 and learning module 130, and is responsible for complete integration of the playing process and learning process according to the events. A triggered event type can be categorized into active and passive triggered events. Active triggered events are events triggered randomly by event-triggering module 140 during the playing process by the system. Passive triggered events are events triggered by the users' operation control to the predetermined events during the playing process.

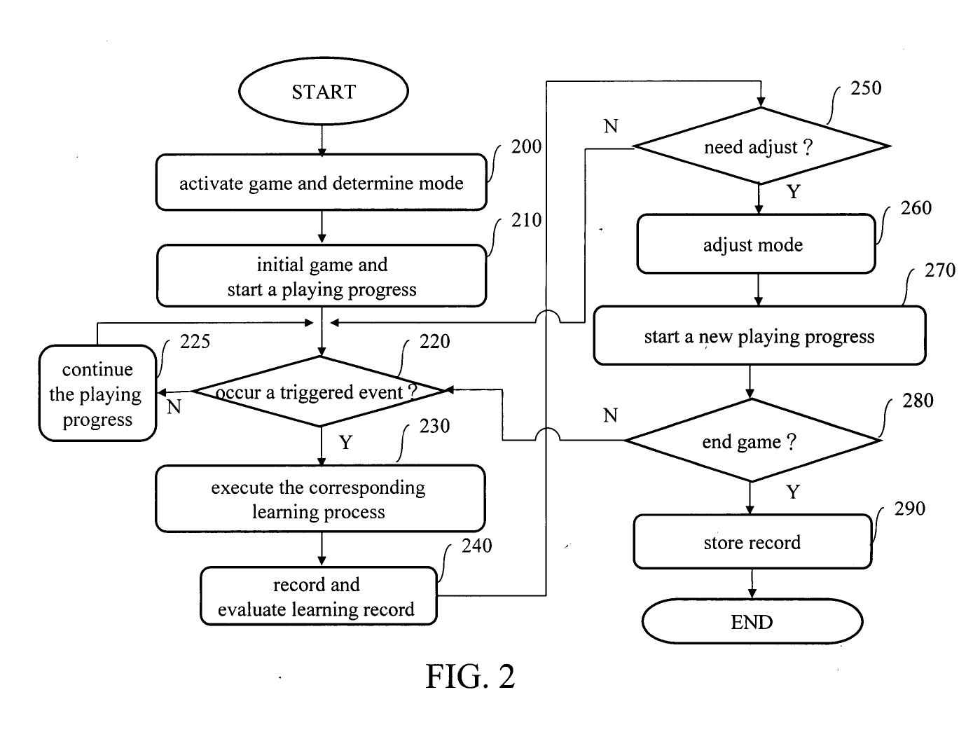

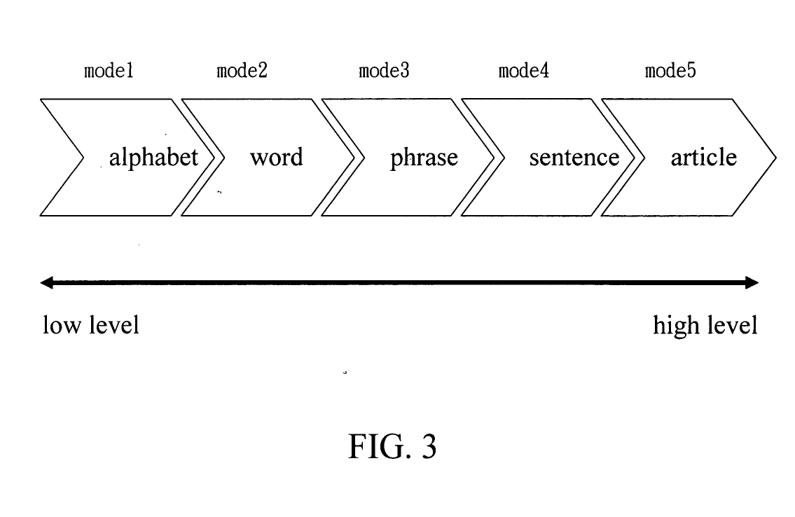

FIG. 2 illustrates the flow diagram of the invented method. First, activate the game (activating playing platform 100) and input the system predetermined playing mode and learning mode (step 200). The predetermined playing mode and learning mode can be determined by users prior to the activation of the game, by using the user control interface 110, and they can also be determined using users' stored learning records and evaluation results from a previous ended learning process. Then, according to the playing mode, execute the game initialization and start executing the playing process (step 210). Users can begin controlling different operations of the game using the user control interface 110. The playing process begins to monitor if any triggered event has occurred (step 220). When active or passive events occur, activate the learning mode and execute the corresponding learning process (step 230). Active triggering is automatically activated by the event triggering module 140 randomly during the playing process; passive triggering uses the users' operation controls responding to the predetermined events during the playing process to generate the event. If no triggered events occur, the playing process is continued (step 225), and it continues to simultaneously monitor the occurrence of triggered events (step 220). During the execution of the learning process, the users learning conditions is recorded and evaluated (step 240). The results of the evaluation are calculated mathematically and quantified to determine the learning conditions of the users. According to the evaluation result, determine if learning adjustments are needed (step 250). If no adjustments are needed, return to step 220 and continue the playing process and keep determining if new triggered events have occurred. If adjustments are needed, learning mode and playing mode are reset using the evaluation result (step 260). Learning mode's adjustments are explained more detailed using FIG. 3 later. Playing mode's adjustments can be determined using the learning mode or by system predetermined methods. After the adjustments, the new playing mode is used to execute the new playing process (step 270). The triggered events produced by the new playing process will execute the new learning mode's learning process. After completing the playing mode and learning mode adjustments and starting to execute a new playing process, the system will determine if users desire to terminate game learning (step 280). In fact, users can terminate game learning executions at any time after the game activation, using the user control interface 110, so step 280 is not limited to the operation method described in the flowing process. If the users do not terminate game learning, the flowing steps return to step 220 and continue the playing process and continue to determine if new triggered events have occurred. If users terminate game learning, all the learning records and evaluations results are saved (step 290) and can be used when game learning is setting the initialization playing mode and learning mode. It can also be used as source for other learning analyzing software to provide a learning result analysis. For adjustments for the learning mode, please refer to FIG. 3. The invention's example divides the language learning language elements from low level to high level (from learning difficulty easy to hard) into five modes; they are: the alphabet (mode 1), words (mode 2), phrases (mode 3), sentences (mode 4) and articles (mode 5). Usually, the system starts with a predetermined value of mode 1, and adjusts to a higher or even lower level suing the learning process according to user's learning condition to achieve the goal of progressive language learning. Users can also use personal perferrence to change the setting using a user control interface 110, or the described five modes can also use system random selection to execute the learning process. The invention also provides a better example.

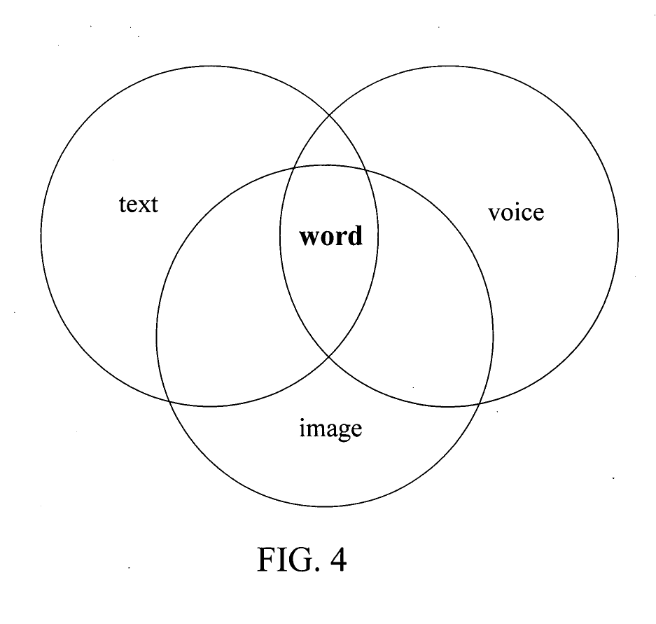

The different modes of language elements in the learning process have combination conditions that allow multiple choices. For example, using FIG. 4, language element “words” can be represented using text, voice, or images (including still pictures or animated pictures), or multimedia conditions using random combinations of text, voice, and images. The final learning process representing method also has to cooperate with the playing process, but this known technical method is not an emphasized point by this invention, so it is not discussed here.

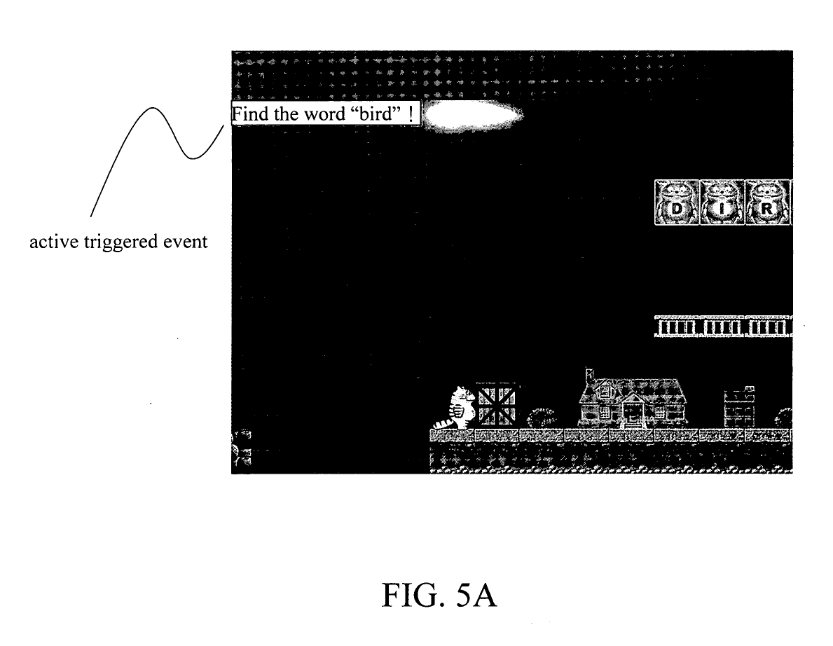

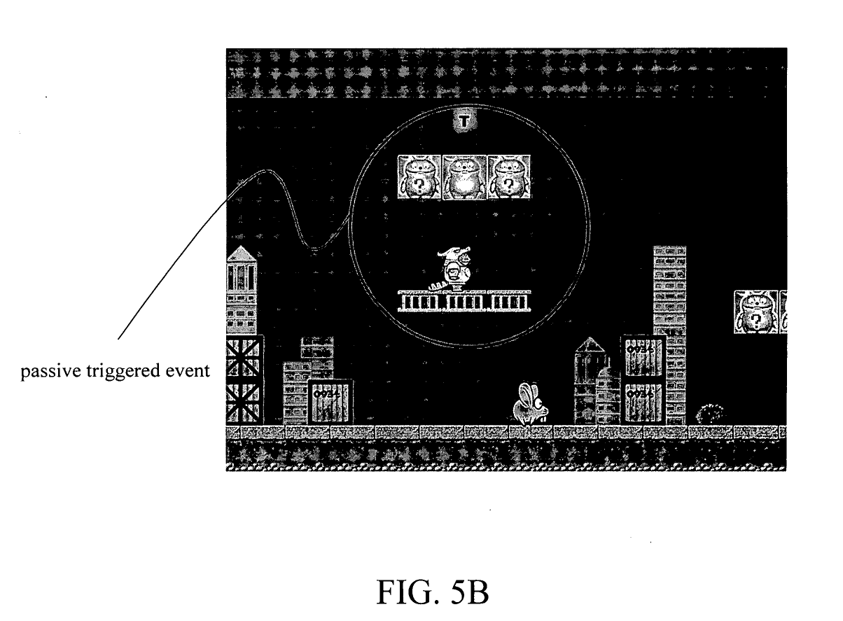

Finally, FIG. 5a and FIG. 5b are examples of playing platform 100. FIG. 5a represents an active triggered event example of the invention. During the playing process, event triggering module 140 actively uses a random method to activate the learning process and allow users to start learning, such as: asking users to execute an operation control to find the word “bird” during the playing process on screen. FIG. 5b represents a passive triggered event example of the invention. During the playing process, the user can operate controls freely to find predetermined events and triggers them, such as: a user operation controlling playing character to jump and hit a “?” item on screen. Like this, the event triggers and produces the learning process of alphabet T. In fact, regardless of active or passive triggered events, the actual presentation condition can be changed freely, and not limited by the methods described by the example of the invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A computer game combined progressive language learning system, which comprises:
a playing module, used to provide a playing process according to a predetermined playing mode, and receives a operation control to execute the playing process, further comprising:
a playing element database, used to store playing elements needed by said playing process of said playing mode; and
a playing operating unit, used to receive said operation control to the playing process, then retrieves at least one playing element from said playing element database to procude said corresponding playing process, and receives said operating control to the playing process;
an user control interface, used to provide said operation control to playing process and learning process;
a event triggering module, requesting a corresponding learning process according to a triggered event produced during the playing process; and
a learning module, used to provide the learning process according to predetermined learning mode and receives the operation control to execute said learning process, further comprising:
a language element database, used to store needed language elements by said learning process of said learning mode;
a learning executing unit, according to said triggered event, retrieving at least one language element to produce said corresponding learning process and receiving said operation control to said learning process; and
a learning adjustment unit, used to adjust said playing mode and said learning mode according to a learning and evaluation record.

2. The computer game combined progressive language learning system of claim 1, wherein said user control interface further comprises procedure for providing said playing mode and said learning mode.

3. The computer game combined progressive language learning system of claim 1, wherein said triggered events comprises of two types, active triggered events and passive triggered events.

4. The computer game combined progressive language learning system of claim 1, wherein said learning adjustment unit further comprises procedure for executing learning recording and evaluating during said learning process.

5. The computer game combined progressive language learning system of claim 4, wherein said learning adjustment unit further comprises procedure for storing said learning record when said playing process and said learning process are terminated.

6. The computer game combined progressive language learning system of claim 1, wherein said learning mode is one selected from the group consisting of alphabets, words, phrases, sentences and articles.

7. The computer game combined progressive language learning system of claim 6, wherein said language element is one selected from the group consisting of text, sound and image.

8. A computer game combined progressive language learning method, which comprises the steps of:
activating game and determine a playing mode and a learning mode;
executing game initialization and starting a playing progress according to said playing module;
activating said learning mode and executing a corresponding learning progress as a triggered event occur;
recording and evaluating learning records in said learning process, and store the learning records; and
adjusting said learning mode and said playing mode instantaneously according to said learning records.

9. The computer game combined progressive language learning method of claim 8, wherein said learning mode is one selected from the group consisting of alphabets, words, phrases, sentences and articles.

10. The computer game combined progressive language learning method of claim 9, wherein said learning mode's language element is one selected from the group consisting of text, sound and image.

11. The computer game combined progressive language learning method of claim 8, wherein said triggered events comprises of two types, active triggered events and passive triggered events.

12. The computer game combined progressive language learning method of claim 8, wherein said method further comprises step of storing said learning record when playing process and learning process are terminated.

13. The computer game combined progressive language learning method of claim 8, wherein said method further comprises a step of using a user control interface for providing said playing mode and said learning mode.
